(19) United States
(12) Patent Application Publication
(10) Pub. No.: US 2007/0287336 A1
(43) Pub. Date: Dec. 13, 2007

(54) Electrical connectors with alignment guides

(76) Inventors: Jonathan E. Buck, Hershey, PA (US); Donald K. Harper, Camp Hill, PA (US); Lee William Potteiger, Lewisberry, PA (US); John M. Spickler, Columbia, PA (US)

Correspondence Address: WOODCOCK WASHBURN, LLP, CIRA CENTRE, 12TH FLOOR, 2929 ARCH STREET, PHILADELPHIA, PA, 19104-2891, US

(21) Appl. No.: 11/450,606

(22) Filed: Jun. 9, 2006

(51) Int. Cl. H01R 13/64

(52) U.S. Cl. 439/680

(57) ABSTRACT

Electrical connectors of the present invention include alignment guides that provide rough connector alignment, vary an electrical contact mating wipe distance, and provide partial separation between two mating electrical connectors. The alignment guides can be, for example, electrically insulative posts that are received in silos formed in the housings of the electrical connectors.

### FIELD OF THE INVENTION

The present invention relates to a electrical connectors. More particularly, the invention relates to electrical connectors having stack heights and contact mating wipe distances that can be varied through the use of appropriately-sized alignment guides.

### BACKGROUND OF THE INVENTION

Mezzanine connector systems typically comprise a plug connector and a receptacle connector that mates with the plug connector. An example is described in U.S. Pat. No. 6,152,747 to McNamara, herein incorporated by reference in its entirety.

The overall height of the mezzanine connector system in the direction of mating is commonly referred to as the stack height of the connector system. A specific stack height is often required for a particular application. If necessary, the stack height can be increased by the use of a spacer. For example, please see U.S. Pat. No. 6,869,292 to Johnescu et al., assigned to the applicant and herein incorporated by reference in its entirety.

### SUMMARY OF THE INVENTION

The present invention includes alignment guides that provide rough connector alignment, vary an electrical contact mating wipe distance, and provide partial separation between two mating electrical connectors.

Preferred embodiments of electrical connectors comprise an electrically insulative housing and two or more electrical contacts carried by the housing. The two or more electrical contacts have free mating portions that extend in a first direction with respect to the housing and mounting portions that extend in a second direction through holes defined by the housing. The electrical connectors also comprise an alignment guide connected to the housing. The free mating portions of the two or more electrical contacts define a contact wipe distance, and the alignment guide limits the wipe distance to a maximum wipe distance.

Preferred embodiments of mezzanine connector systems comprise a receptacle connector comprising a first electrically insulative housing and a first electrically conductive contact mounted on the first housing, and a plug connector comprising a second electrically insulative housing and a second electrically conductive contact mounted on the second housing. The plug connector is matable with the receptacle connector in a first and a second mating position. The second contact wipes the first contact along a first length of the first contact when the plug and receptacle connectors are mated to the first mating position. The second contact wipes the first contact along a second length of the first contact greater than the first length of the first contact when the plug and receptacle connectors are mated to the second mating position. At least one of the first and second housings has an alignment guide mounted thereon that prevents relative movement between the plug and receptacle connectors in a direction of mating as the plug and receptacle connectors reach the first mating position.

Preferred embodiments of electrical connectors capable of mating with a second electrical connector comprise an electrically insulative housing, a first electrically-conductive contact mounted on the housing, and an alignment guide that stops relative movement between the electrical connectors during mating thereof. The electrical connectors have a first stack height and the first contact is wiped by a contact of the second electrical connector by a first distance when the alignment guide is configured in a first state. The electrical connectors have a second stack height and the first contact is wiped by the contact of the second electrical connector by a second distance during mating when the alignment guide is configured in a second state.

### BRIEF DESCRIPTION OF THE DRAWINGS

The foregoing summary, as well as the following detailed description of a preferred embodiment, are better understood when read in conjunction with the appended diagrammatic drawings. For the purpose of illustrating the invention, the drawings show an embodiment that is presently preferred. The invention is not limited, however, to the specific instrumentalities disclosed in the drawings. In the drawings:

FIG. 1 is a perspective view of a mezzanine connector system with alignment and variable wipe distance features according to the present invention;

FIG. 2 is a perspective view of a plug connector shown in FIG. 1;

FIG. 3 is a perspective view of a receptacle connector shown in FIG. 1;

FIG. 4 is a cross-sectional view of the connector system shown in FIG. 1, taken along cross-section line I-I;

FIG. 5 cross-sectional view of a second embodiment mezzanine connector system according to the present invention;

FIG. 6 is a perspective view of a third embodiment mezzanine connector system according to the present invention; and

FIG. 7 is a magnified view of the area designated “A” in FIG. 6.

### DETAILED DESCRIPTION OF ILLUSTRATIVE EMBODIMENTS

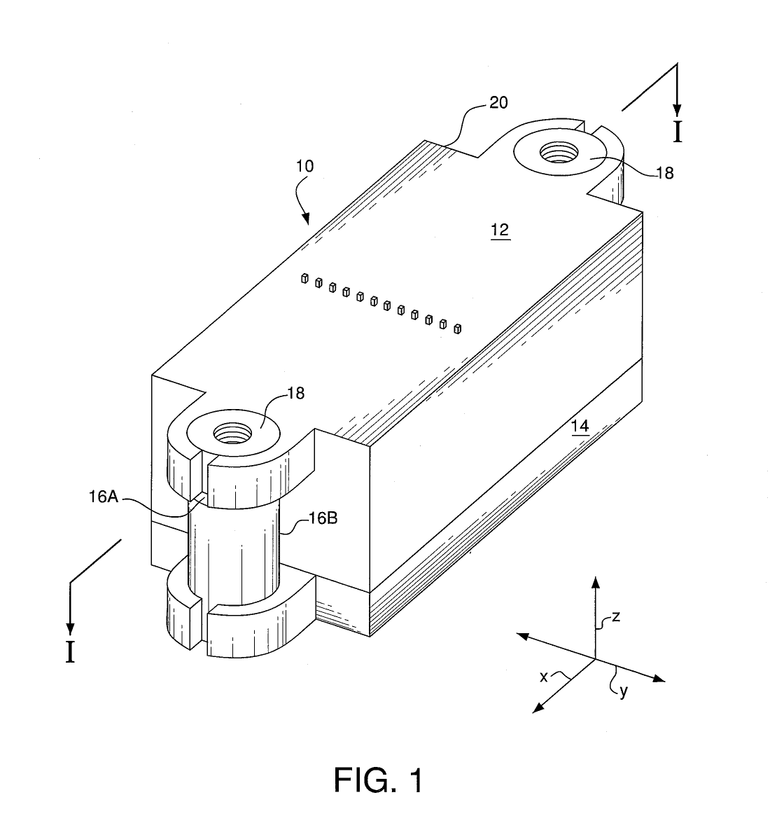

As shown in FIG. 1, a mezzanine connector system 10 according to one embodiment of the present invention includes a plug connector 12 and a receptacle connector 14 that mates with the plug connector 12. The plug connector 12 can be mounted on a first substrate, and the receptacle connector 14 can be mounted on a second substrate. The first and second substrates are not shown in the figures, for clarity of illustration. The plug and receptacle connectors 12, 14, upon mating, electrically connect the first and second substrates. The plug and receptacle connectors 12, 14 can be attached to two parallel substrates, and may be attached to the substrates by surface mount, ball grid array, press-fit, or other suitable types of terminations.

The present invention includes integrally formed or removable alignment guides provide as rough alignment, add space between the plug and receptacle connectors 12, 14, and help regulate contact wipe distance. The alignment guides are preferably one or more posts 16A received in one or more corresponding hollow silos 16B. Each post 16A or silo 16B preferably defines internal threads or may have a PEM nut 18 and corresponding substrate fastener (not shown) for holding the post 16A, the plug connector 12, and the receptacle connector 14 with respect to the substrate. The posts 16A are preferably removable from a plug housing 20 and may have a tapered or other suitable shape to help with rough alignment of the plug connector 12 and the receptacle connector 14.

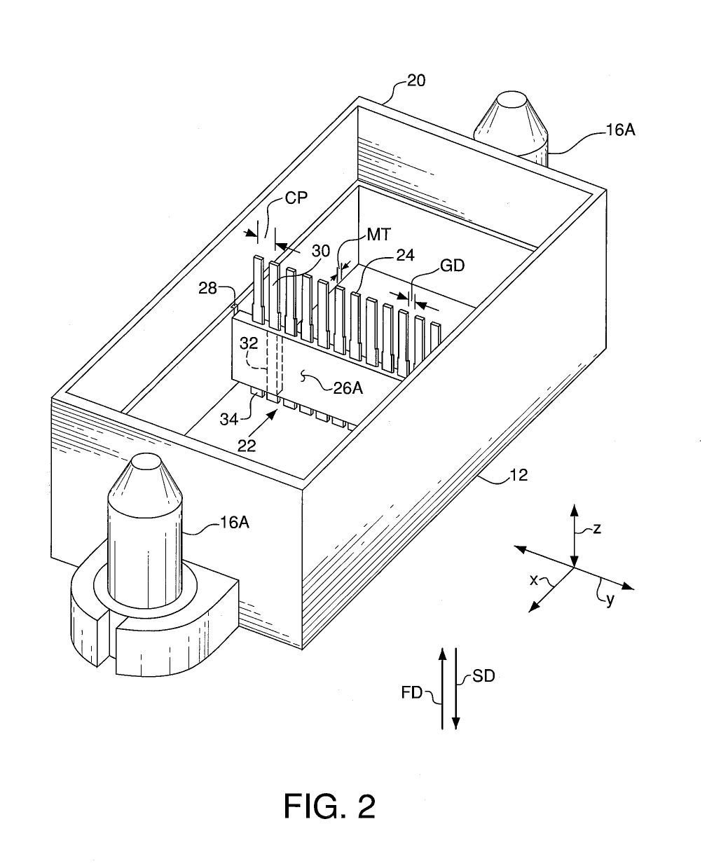

As shown in FIG. 2, the plug connector 12 includes one or more removable plug insert-molded leadframe assemblies (IMLAs) 22 that are preferably positioned parallel to one another inside of the plug housing 20. Each plug IMLA 22 comprises electrical plug contacts 24 that are electrically isolated from one another by a dielectric material, such as a plastic overmold 26A. The plug IMLAs 22 may be mounted on the plug housing 20 via an interference fit with the plug housing 20, by a tab and slot 28 arrangement, or other suitable manner of attachment. The plug IMLAs 22 are preferably spaced apart from each other by one to two millimeters.

The plug contacts 24 are spaced apart from one another by a gap distance GD. The gap distance GD is a function of dielectric material positioned in the gap distance GD and the material thickness MT of the plug contacts 24 themselves. For example, if the plug contacts 24 have a material thickness of about 0.1 to 0.4 mm, then the gap distance GD in air is about 0.1 to 0.4 mm for high speed differential signaling. A material thickness MT and a corresponding gap distance GD in air of about 0.2 mm is preferred. In plastic, the material thickness MT generally decreases and the gap distance GD increases. High speed signaling is generally defined herein as a bit rate above 2 Gigabits/sec, such as 3-20 Gigabits/sec. These bit rates generally correspond to rise times of about 200-30 ps with six percent or less of multiactive, worse-case crosstalk. The plug contacts 24 can also be configured to carry single-ended signals.

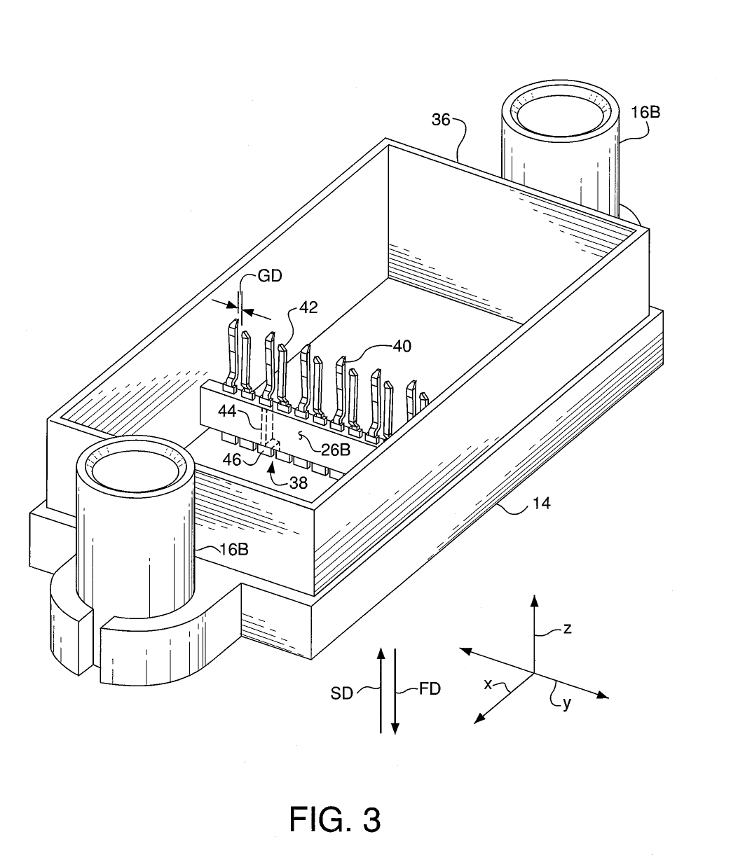

With continuing reference to FIG. 2, the plug contacts 24 can be arranged along a linear array within each plug IMLA 22, with a contact pitch CP of about 0.7 to 1.5 mm, with about 1 mm being preferred. The plug contacts 24 each include a free-ended plug mating portion 30, a plug intermediate portion 32 that adjoins the plug mating portion 30, and a plug mounting portion 34 that adjoins the plug intermediate portion 32. The plug mating portion 30, the plug intermediate portion 32, and the plug mounting portion 34 are substantially aligned in the z-direction. As noted below in connection with FIG. 3, the plug mating portions 30 are sized with respect to the plastic overmold 26A in a first direction FD to permit mechanical and electrical complementary mating with receptacle contacts in the receptacle connector 14 when the connector system 10 is disposed in different stack heights. The plug mounting portions 34 extend in a second direction SD through the plug housing 20 and a solder ball, press-fit tail, or other suitable termination is positioned adjacent to a mounting surface of the plug housing 20.

Referring now to FIGS. 1 and 3, the receptacle connector 14 is designed to electrically and mechanically mate with the plug connector 12. As shown in FIG. 3, the receptacle connector 14 includes a receptacle housing 36 with one or more silos 16B and one or more removable receptacle IMLAs 38 that are preferably positioned parallel to one another inside of the receptacle housing 36. Each receptacle IMLA 38 comprises free-ended electrical receptacle contacts 40 that are electrically isolated from one another by a dielectric material, such as plastic overmold 26B. The receptacle IMLAs 38 may be mounted on the receptacle housing 36 via an interference fit with the receptacle housing 36, by a tab and slot arrangement, or other suitable manner of attachment. The receptacle IMLAs 38 are preferably spaced apart 1 to 2 mm.

The receptacle contacts 40 preferably extend a fixed distance in a second direction SD from the plastic overmold 26B, and are spaced apart from one another by a gap distance GD, as discussed above with respect to the plug connector 12.

With continuing reference to FIG. 3, the receptacle contacts 40 can be arranged along a linear array within each receptacle IMLA 38, with a contact pitch of 0.7 to 1.5 mm, with one millimeter being preferred. The receptacle contacts 40 each include a receptacle mating portion 42, a receptacle intermediate portion 44 that adjoins the receptacle mating portion 42, and a receptacle mounting portion 46 that adjoins the receptacle intermediate portion 44. The receptacle mating portions 42 each extend along the z-axis in the second direction SD. The receptacle mating portions 42 are sized to permit mechanical and electrical complementary mating with the plug mating portions 30 of the plug contacts 24 shown in FIG. 2. As shown in FIG. 3, the receptacle mating portion 42 of each alternating receptacle contact 40 can extend along the x-axis. This allows for alternating surface mating with respective opposite sides of individual, adjacent ones of the plug contacts 24. The receptacle mounting portions 46 extend in the first direction through the receptacle housing and terminate in a solder ball or some other suitable substrate attachment.

Specific details of the IMLAs 22, 38 and the contacts 24, 40 are described for exemplary purposes only. The principles of the invention can be applied to connector systems comprising other types of IMLAs and contacts, and to connector systems that do not use IMLAs.

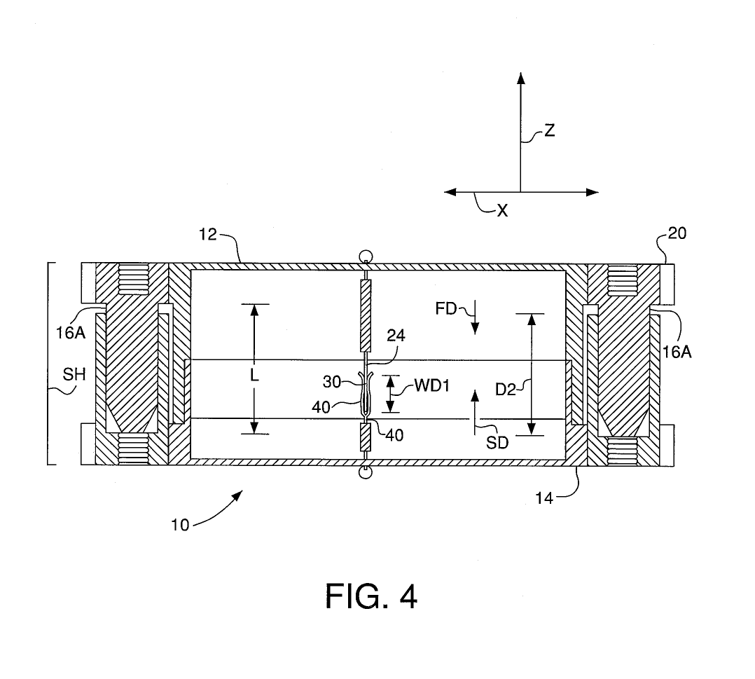

Turning to FIG. 4 and briefly recapping FIGS. 1-3, the plug housing 20 of the plug connector 12 is configured to retain one or more removable posts 16A. The receptacle housing 36 defines one or more silos 16B that receive individual ones of the posts 16A as the plug connector 12 is moved in the first direction FD toward the receptacle connector 14. The posts 16A and silos 16B act as an initial rough alignment between the plug connector 12 and receptacle connector 14 and ultimately restrain movement of the plug connector 12 in the first direction FD with respect to the receptacle connector 14 during mating of the plug and receptacle connectors 12, 14. The post or posts 16A can be sized in the first direction FD to produce a particular stack height SH and wipe distance WD1 for the mezzanine connector system 10.

Two substantially identical posts 16A are shown in FIG. 4. If the depth D1 of the silos remains constant, a length L of the posts 16A will define a first wipe distance WD1 between the plug mating portions 30 and the receptacle mating portions 40 of the respective plug and receptacle contacts 24, 40. Therefore, the posts 16A perform two duties- alignment and setting a particular mating portion wipe distance WED1. The wipe distance WD1 may be about 1-5 mm, with about 2-4 mm being preferred. Differing wipe distances can be obtained by varying the length L of the guide or guides 16A and keeping the silo depth D1 constant.

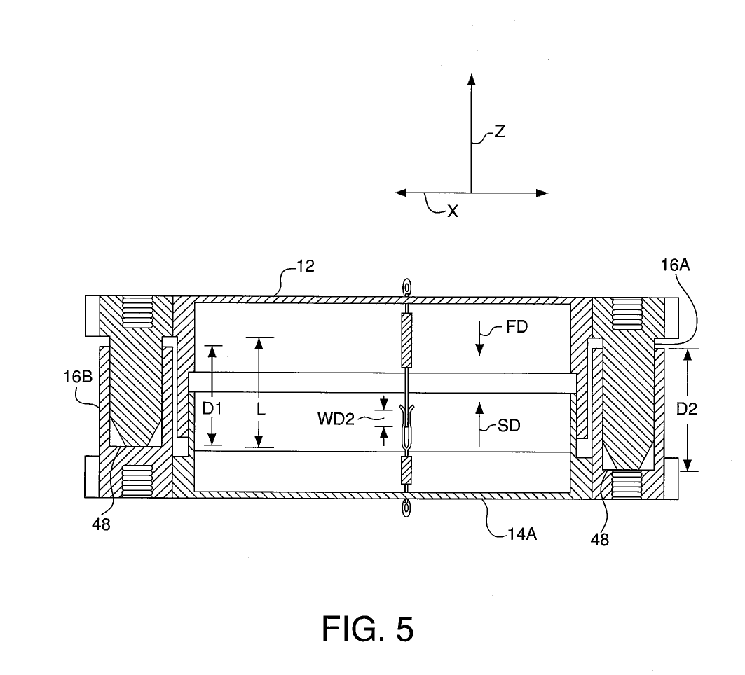

Another embodiment of the present invention is shown in FIG. 5. In this embodiment, silos 16B have different depths D1, D2 in the first direction FD. Therefore, silos 16B that have differing depths may also be used to accomplish alignment and a desired wipe distance if the post 16A length L is constant. Stated another way, the present invention can decrease the depth D1, D2 of a silo base wall 48 instead of increasing the length of the guides 16A. As also shown in FIG. 5, depth D1 is less than depth D2. Therefore, post 16A is longer in the silo 16B with a depth of D2.

The present invention is not limited to solid guides 16A Guides that telescopically expand or contract between different overall lengths can also be used. Each telescoping guide can be formed from two or more pieces. The pieces can be connected by way of threaded studs or other suitable means to facilitate the telescopic movement. Guides formed from interlocking pieces can also be used. The interlocking pieces can be stacked to form the guide. The overall length L of the guide can be increased or decreased by adding or removing one or more of the interlocking pieces to or from the stack.

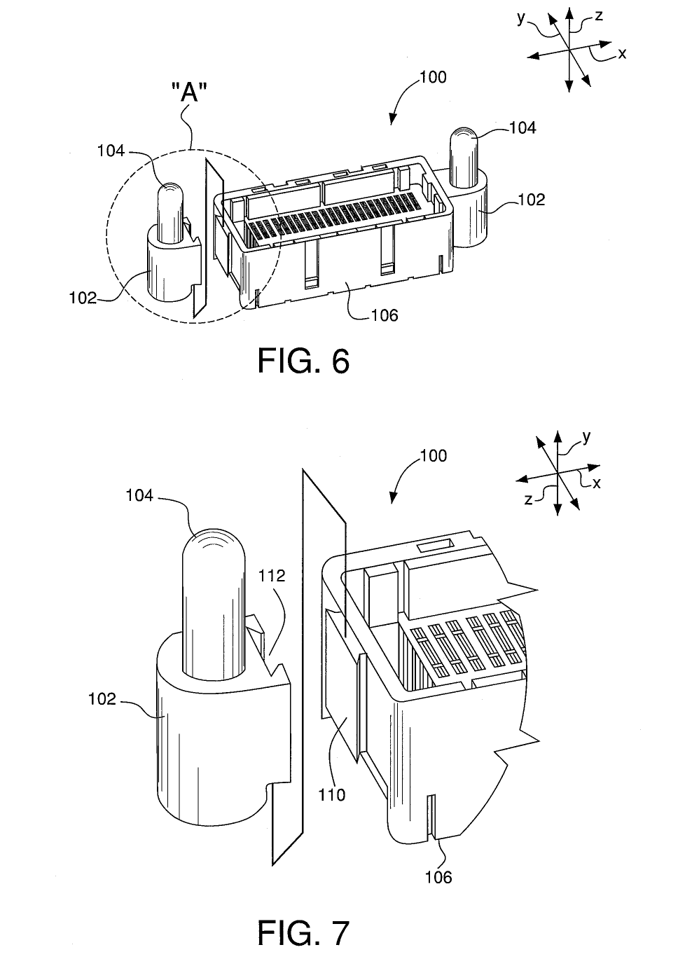

FIGS. 6 and 7 depict an alterative embodiment in the form of a connector 100. The connector 100 includes silos 102 each having an alignment guide 104 mounted therein. The silos 102 are removably attached to a housing 106 of the connector 100 by a suitable means. For example, the housing 106 can include dovetails 110, and each silo 102 can have a slot 112 formed therein to receive an associated one of the dovetails 110.

The above-noted arrangement permits the connector 100 to be mounted on its mounting substrate without the alignment guides 104 touching the substrate. The alignment guides 104 can be mated with the housing 106, or can be moved downward on the housing 106 and into contact with the substrate once the connector 100 has been mounted using a reflow attachment process. The alignment guides 104 can be attached to the substrate by, for example, lock screw hardware that accesses the alignment pins 104 from on the opposite side of the substrate, or with a press-fit application to the substrate.

Contact between the alignment guides 104 and the substrate can generate mechanical forces on the connector 100 that interfere with the ability of the connector 100 to self-center during the reflow attachment process, potentially degrading the reliability of the resulting solder connections. The ability to mount the connector 100 without contact between the alignment guides 104 and the substrate can eliminate the potential for such forces to occur.

1. An electrical connector, comprising:
an electrically insulative housing and two or more electrical contacts carried by the housing, the two or more electrical contacts having free mating portions that extend in a first direction with respect to the housing and mounting portions that extend in a second direction through holes defined by the housing; and
an alignment guide connected to the housing,
wherein the free mating portions of the two or more electrical contacts define a contact wipe distance, and the alignment guide limits the wipe distance to less than a maximum wipe distance.

2. The electrical connector as claimed in claim 1, wherein the alignment guide is an electrically insulated post that extends in the first direction beyond the mating portions of the two or more electrical contacts.

3. The electrical connector as claimed in claim 2, wherein the electrically insulated post is adjustable in length in the first direction and a second direction that is opposite to the first direction.

4. The electrical connector as claimed in claim 1, wherein the alignment guide is adjustable in length in the first direction and a second direction that is opposite to the first direction.

5. The electrical connector as claimed in claim 1, further comprising a second electrically insulative housing and two or more mating electrical contacts carried by the second housing, the two or more mating electrical contacts having second mating portions that electrically mate with the mating portions of the electrical contacts along the wiping distance.

6. The electrical connector as claimed in claim 5, wherein the alignment guide provides rough alignment for the electrically insulative housing and the second electrically insulative housing.

7. The electrical connector as claimed in claim 1, wherein the alignment guide is a hollow silo, the hollow silo defines a base wall, and the base wall is adjustable in height in a second direction that is opposite to the first direction.

8. A mezzanine connector system, comprising:
a receptacle connector comprising a first electrically insulative housing and a first electrically conductive contact mounted on the first housing; and
a plug connector comprising a second electrically insulative housing and a second electrically conductive contact mounted on the second housing, the plug connector being matable with the receptacle connector in a first and a second mating position, wherein the second contact wipes the first contact along a first distance of the first contact when the plug and receptacle connectors are mated to the first mating position, the second contact wipes the first contact along a second distance of the first contact greater than the first distance of the first contact when the plug and receptacle connectors are mated to the second mating position, and at least one of the first and second housings has an alignment guide mounted thereon that prevents relative movement between the plug and receptacle connectors in a direction of mating as the plug and receptacle connectors reach the first mating position.

9. The connector system as claimed in claim 8, wherein the plug and receptacle connectors have a first stack height when the plug and receptacle connectors are mated to the first mating position, and a second stack height shorter than the first stack height when the plug and receptacle connectors are mated to the second position.

10. The connector system as claimed in claim 8, wherein the alignment guide is an electrically insulative post.

11. The connector system as claimed in claim 10, wherein the post is removably mounted on the at least one of the first and second housings.

12. The connector system as claimed in claim 11, wherein the plug and receptacle connectors can move from the first to the second mating position only when the post is not installed, whereby a wiping distance of the first and second contacts can be varied by removing the post.

13. The connector system as claimed in claim 10, wherein a length of the post in the direction of mating is adjustable.

14. The connector system as claimed in claim 8, wherein the alignment guide provides rough alignment for the first and second housings.

15. The connector system as claimed in claim 8, wherein the alignment guide is a hollow silo, the hollow silo defines a base wall, and the base wall is adjustable in height in the direction of mating.

16. An electrical connector capable of mating with a second electrical connector, comprising:
an electrically insulative housing;
a first electrically-conductive contact mounted on the housing; and
an alignment guide that stops relative movement between the electrical connectors during mating thereof, wherein the electrical connectors have a first stack height and the first contact is wiped by a contact of the second electrical connector by a first distance when the alignment guide is configured in a first state, and the electrical connectors have a second stack height and the first contact is wiped by the contact of the second electrical connector by a second distance during mating when the alignment guide is configured in a second state.

17. The electrical connector as claimed in claim 16, wherein the alignment guide is an electrically-insulative post.

18. The electrical connector as claimed in claim 17, wherein the post is mounted on the housing when the alignment guide is configured in the first state, and the post is not mounted on the housing when the alignment guide is configured in the second state.

19. The electrical connector as claimed in claim 17, wherein a length of the post is adjustable, the post has a first length when the alignment guide is configured in the first state, and the post has a second length when the alignment guide is configured in the second state.

20. The electrical connector as claimed in claim 16, wherein the alignment guide is a hollow silo, the hollow silo defines a base wall, and the base wall is adjustable in height in the direction of mating so that the base wall has a first height when the alignment guide is configured in the first state, and the base wall has a second height when the alignment guide is configured in the second state.

21. The electrical connector as claimed in claim 1, wherein the silo is removably attached to the housing.

22. A method for installing a connector on a substrate, the connector comprising a housing, an electrical contact mounted in the housing, a fusible element attached to the electrical contact, and an alignment guide capable of being mated with the housing, the method comprising:
positioning the connector on the substrate;
aligning the fusible element with a solder pad on the substrate;
conducting a reflow operation that forms an electrical connection between the electrical contact and the solder pad; and
subsequently moving the alignment guide toward the substrate.

23. The method of claim 22, wherein subsequently moving the alignment guide toward the substrate comprises moving the alignment guide into contact with the substrate.

24. The method of claim 22, further comprising mating the alignment guide with the housing after conducting the reflow operation.

25. The method of claim 22, further comprising conducting the reflow operation while the alignment guide is mated with the housing.

26. The electrical connector of claim 1, further comprising two or more solder balls mounted respectively on the two or more electrical connectors.

27. The mezzanine connector system of claim 8, wherein the receptacle connector further comprises a first solder ball mounted on the first electrically conductive contact; and the plug connector further comprises a second solder ball mounted on the second electrically conductive contact.

28. The electrical connector of claim 16, further comprising a solder ball mounted on the first electrically-conductive contact.
